(19) United States
(12) Patent Application Publication
(10) Pub. No.: US 2013/0125697 A1
(43) Pub. Date: May 23, 2013

(54) PEDAL FORCE ADJUSTING APPARATUS FOR ACCELERATOR PEDAL

(71) Applicants: Eun Sik Kim, Daegu (KR); Jeong Seon Min, Hwaseong-si (KR); Yong Lee, Hwaseong-si (KR); Yang Rae Cho, Hwaseong-si (KR); Sun Geun Kim, Gyeongsan-si (KR)

(72) Inventors: Eun Sik Kim, Daegu (KR); Jeong Seon Min, Hwaseong-si (KR); Yong Lee, Hwaseong-si (KR); Yang Rae Cho, Hwaseong-si (KR); Sun Geun Kim, Gyeongsan-si (KR)

(73) Assignees: Kia Motors Corp., Seoul (KR); Hyundai Motor Company, Seoul (KR)

(21) Appl. No.: 13/495,681

(22) Filed: Jun. 13, 2012

(30) Foreign Application Priority Data
Nov. 23, 2011 (KR) 10-2011-0122898

(51) Int. Cl. G05G 1/40

(52) U.S. Cl. 74/513

(57) ABSTRACT

A pedal force adjusting apparatus for an accelerator pedal regulates a resilient force of a resilient member through movement of a carrier using a pedal force adjusting tool and easily regulates a pedal force of a pedal arm if necessary.

### CROSS-REFERENCE TO RELATED APPLICATION

The present application claims priority of Korean Patent Application Number 10-2011-0122898 filed Nov. 23, 2011, the entire contents of which application is incorporated herein for all purposes by this reference.

### BACKGROUND OF INVENTION

1. Field of Invention

The present invention relates to a pedal force adjusting apparatus for an accelerator pedal. More particularly, it relates to an apparatus for adjusting a pedal force of an accelerator pedal which can adjust the pedal effort of the accelerator pedal by a simple operation of a user.

2. Description of Related Art

As illustrated in FIG. 1, a conventional accelerator pedal apparatus includes a pedal arm housing fixedly installed in a dash panel under a driver's seat, a pedal arm 2 having one end at which a pedal 2a is installed and an opposite end inserted into the pedal housing and installed within the pedal arm housing 1 to be rotated with respect to the pedal arm housing 1, a spring plate 3 which is coupled to an end of the pedal arm 2 located within the pedal arm housing 1, a friction shoe 4 coupled to an end of the pedal arm 2 located within the pedal arm housing 1 to frictionally interferes with the inner wall surface of the pedal arm housing 1 drum when the pedal arm 2 is rotated, and a resilient member 5 having one end supported by the spring plate 3 and an opposite end supported by an inner surface of the pedal arm housing 1 facing the spring plate 3. The resilient member 5 includes an inner spring 5a and an outer spring 5b.

In the above-mentioned accelerator pedal apparatus, the pedal force is a force obtained by adding a reaction force of the friction shoe 4 which frictionally interferes with an inner wall surface of the pedal arm housing 1 when the pedal arm 2 is rotated about a hinge shaft 2b and a reaction force generated when the inner spring 5a and the outer spring 5b are resiliently compressed.

As a force applied to the pedal arm 2 by a driver becomes larger if a pedal force is large, the fatigue of the driver manipulating the accelerator pedal also increases. On the other hand, when a pedal force is small, a driver cannot sufficiently feel an accelerator pedal manipulating feeling. Consequently, the automotive manufacturers fabricate an accelerator pedal according to the pedal force characteristics of an accelerator pedal which are suitable for safety laws of each nation.

However, in the conventional accelerator pedal apparatus, in order to adjust the pedal effort, the friction shoe 4 and the resilient member 5 should all be changed to new ones. Therefore, the accelerator pedal apparatus cannot be used for common use.

An exemplar of prior an accelerator pedal are described in detail in Korean Patent No. 10-0724700.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a pedal force adjusting apparatus for an accelerator pedal which can properly adjust a pedal force of the accelerator pedal with a simple operation if necessary without exchanging a part, faithfully satisfy safety rules for pedal force, and allow common use of the accelerator pedal.

Various aspects of the present invention provide for a pedal force adjusting apparatus for an accelerator pedal, including: a carrier housing integrally formed with a pedal arm housing facing an end of a pedal arm in a rotating direction of the pedal arm and having housing bosses integrally formed on inner surfaces thereof facing each other; and a carrier installed within the carrier housing such that one end of a resilient member providing a pedal force to the pedal arm is supported thereby and having carrier bosses coupling to the housing bosses and integrally protruding from opposite side surfaces thereof.

The carrier may be installed through coupling of the housing bosses and the carrier bosses so as to be moved in a direction of compressing the resilient member while an external force is applied.

Cutaway recesses may be formed on opposite sides of the carrier facing the housing bosses. A pair of wings which can be resiliently shrunk may be integrally formed in the carrier with the cutaway recesses being interposed therebetween. The carrier bosses may be integrally formed on outer surfaces of the wings.

Each housing boss may include an inclined surface downwardly inclined toward the pedal arm housing from an inner side surface of the carrier housing, and a perpendicular surface connected to an end of the inclined surface in a direction perpendicular to an inner side surface of the carrier housing. The inclined surfaces and the perpendicular surfaces may be alternately formed one by one continuously along a moving direction of the carrier.

For smooth resilient movements of the wings, the remaining surfaces of each cutaway recess except one surface by which one end of the resilient member is supported may be opened.

Each carrier boss may include an inclined surface and a perpendicular surface surface-contacting the inclined surface and the perpendicular surface of the corresponding housing boss. The inclined surfaces and the perpendicular surfaces may be alternately formed one by one continuously along a moving direction of the carrier.

A tool insert hole connected to the outside may be formed in the carrier housing facing an end of the resilient member, and the pedal force adjusting apparatus further may include a pedal force adjusting tool inserted into the tool insert hole to push the carrier.

The pedal force adjusting apparatus for an accelerator pedal according to the present invention can regulate a resilient force of the resilient member by moving the carrier with a simple operation without exchanging a part and accordingly regulate a pedal force of the pedal arm easily if necessary, faithfully satisfying safety rules for pedal force and allowing common use of the accelerator pedal.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a conventional accelerator pedal apparatus.

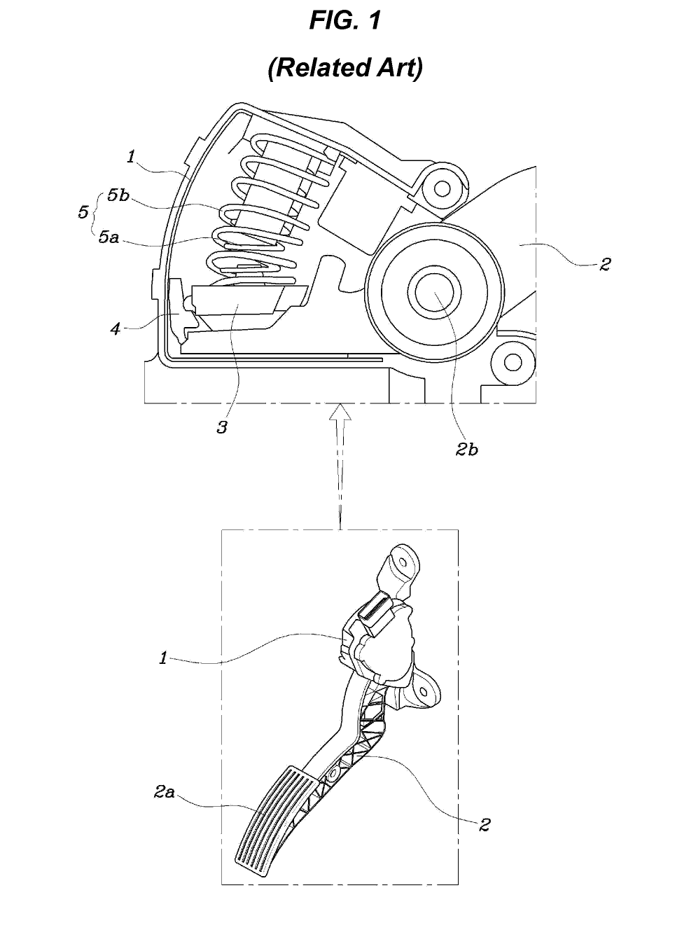

FIG. 2 is a view of an exemplary accelerator pedal including a pedal force adjusting apparatus according to the present invention;

FIG. 3 is a view illustrating an exemplary installation state of the pedal force adjusting apparatus according to the present invention.

FIG. 4 is a view illustrating an exemplary state where a carrier is separated from a carrier housing according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

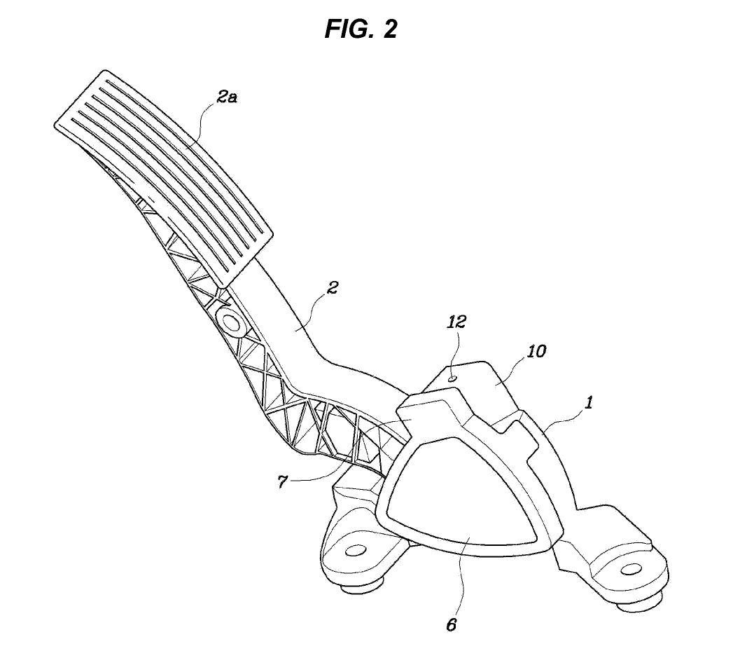

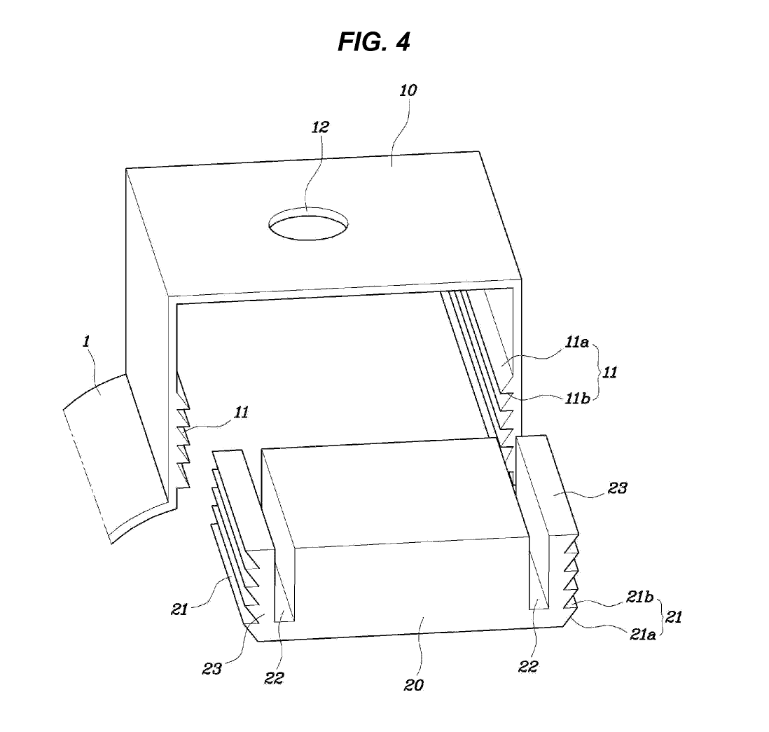

As illustrated in FIGS. 2 to 4, the vehicle accelerator pedal apparatus includes a pedal arm housing 1 fixedly installed in a dash panel under a driver's seat, a pedal arm 2 having a pedal 2a at one end thereof and an opposite end of which is inserted into the pedal arm housing 1 so as to be rotatable about a hinge shaft 2b with respect to the pedal housing 1, a spring plate 3 coupled to an end of the pedal arm 2 located within the pedal arm housing 1, a friction shoe 4 coupled to an end of the pedal arm 2 located within the pedal arm housing 1 so as to frictionally interfere with an inner wall surface of the pedal arm housing 1 while the pedal arm 2 is rotated, and a resilient member 5 installed such that one end thereof is supported by the spring plate 3 and an opposite end thereof is supported by an inner surface of the pedal arm housing 1 facing the spring plate 3. The resilient member 5 includes an inner spring 5a and an outer spring 5b.

In the accelerator pedal apparatus constructed as mentioned above, a sum of a reactive force of the friction shoe 4 frictionally interfering with the inner wall surface of the pedal arm housing 1 while the pedal arm 2 is rotated about the hinge shaft 2b and a reactive force generated while the inner spring 5a and the outer spring 5b is resiliently compressed acts as a pedal force.

The present invention has a construction by which characteristics of a pedal force can be varied by a reactive force of the frictional shoe 4 and a simple manipulation of a user even without exchanging the reactive force of the friction member 5.

That is, the pedal force adjusting apparatus for an accelerator pedal according to the present invention includes a carrier housing 10 integrally and/or monolithically formed with the pedal arm housing 1 facing an end of the pedal arm 2 in a rotating direction of the pedal arm 2 and having housing bosses 11 integrally and/or monolithically formed on opposite inner surfaces thereof facing each other, and a carrier 20 installed within the carrier housing 10 such that one end of the resilient member 5 providing a pedal force to the pedal arm 2 can be supported thereby and having carrier bosses 21 coupling to the housing bosses 11 and integrally and/or monolithically protruding from opposite side surfaces thereof.

Here, the pedal arm housing 1 can be removably assembled with the pedal arm housing cover 1. The carrier housing cover 7 is integrally and/or monolithically formed with the pedal arm housing cover 6. The carrier housing cover 7 can be removably assembled in the carrier housing 10 when the pedal arm housing cover 6 is assembled in the pedal arm housing 1.

The carrier 20 is installed through coupling of the housing bosses 11 and the carrier bosses 21 so as to be moved only in a direction of compressing the resilient member 5 while an external force is applied.

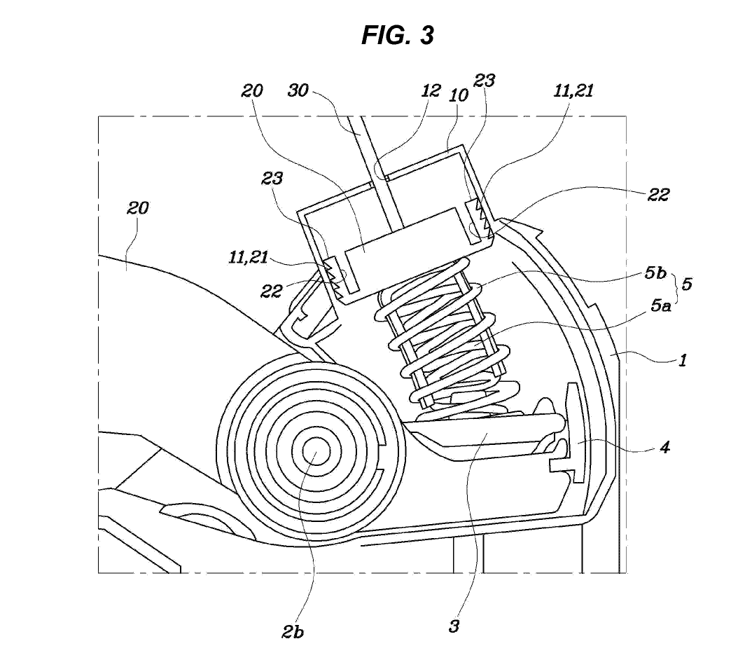

That is, when an external force is applied with the housing bosses 11 and the carrier bosses 21 being coupled to each other, the carrier 20 can be moved only in a direction (in which the carrier is moved along the carrier housing in a state of FIG. 3) of compressing the resilient member 5, and a movement of the carrier 20 in an opposite direction is not allowed. The coupling of the housing bosses 11 and the carrier bosses 21 should be released to allow a movement of the carrier 20 in an opposite direction (in which the carrier is moved upward along the carrier housing in a state of FIG. 3).

Cutaway recesses 22 are formed on opposite sides of the carrier 20 facing the housing bosses 11, and a pair of wings 23 which can be resiliently shrunk are integrally and/or monolithically formed in the carrier 20 with the cutaway recesses 20 being interposed therebetween. The carrier bosses 21 are integrally and/or monolithically formed on outer surfaces of the wings 23.

Here, for smooth resilient movements of the wings 23, the remaining surfaces of each cutaway recess 22 except one surface by which one end of the resilient member 5 is supported are opened.

Each housing boss 11 includes an inclined surface 11a downwardly inclined toward the pedal arm housing 1 from an inner side surface of the carrier housing 10, and a perpendicular surface 11b connected to an end of the inclined surface 11a in a direction perpendicular to an inner side surface of the carrier housing 10. The inclined surfaces 11a and the perpendicular surfaces 11b are alternately formed one by one continuously along a moving direction of the carrier 20.

Each carrier boss 21 includes an inclined surface 21a and a perpendicular surface 21b surface-contacting the inclined surface 11a and the perpendicular surface 11b of the corresponding housing boss 11. The inclined surfaces 21a and the perpendicular surfaces 21b are alternately formed one by one continuously along a moving direction of the carrier 20.

The carrier 20 can be moved only in a direction of compressing the resilient member 5 when an external force is applied to the carrier 20 while the housing bosses 11 and the carrier bosses 21 are coupled to each other, by means of the inclined surfaces 11a and the perpendicular surfaces 11b of the housing bosses 11 and the inclined surfaces 21a and the perpendicular surfaces 21b of the carrier bosses 21.

A tool insert hole 12 connected to the outside is formed in the carrier housing 10 facing an end of the resilient member 5, and the apparatus of the present invention further includes a pedal force adjusting tool inserted into the tool insert hole 12 to push the carrier 20.

Hereinafter, an operation of the apparatus of the present invention will be described.

If a drive pushes the pedal 2a to rotate the pedal arm 2 while a pedal force is not adjusted, since even though the resilient member 5 is compressed and the resilient force then is transferred to the carrier 20, the carrier 20 remains fixed by the coupling of the housing bosses 11 and the carrier bosses 21 while the accelerator pedal is being normally operated.

That is, since even though the resilient member 5 is compressed and a compression force of the resilient member 5 is transferred to the carrier 20 during rotation of the pedal arm 2, the perpendicular surfaces 11b of the housing bosses 11 and the perpendicular surfaces 21b of the carrier bosses 21 surface-contact each other, it is impossible for the carrier 20 to be lifted toward the upper side of the carrier housing 10 having the tool insert hole 12. Accordingly, since the carrier 20 remains fixed, the accelerator pedal can be normally operated.

If an operator inserts the pedal force adjusting tool 30 into the tool insert hole 12 of the carrier housing 10 to adjust a pedal force and then pushes it with a predetermined force, the carrier 20 is moved in a direction of pushing the resilient member 5. Accordingly, since the resilient member 5 is compressed and deformed while increasing resilient force, a pedal force of the pedal arm 2 is adjusted to increase gradually.

That is, if the pedal force adjusting tool 30 pushes an upper surface of the carrier 20 in the state of FIG. 3, as the inclined surfaces 21a of the carrier bosses 21 are moved along the inclined surfaces 11a of the housing bosses 11, the carrier 20 is moved in a downward direction of pushing the resilient member 5. Accordingly, as a resilient force of the resilient member 5 increases, a pedal force of the pedal arm 2 also gradually increases.

After a pedal force is completely adjusted due to the movement of the carrier 20, the perpendicular surfaces 11b of the housing bosses 11 and the perpendicular surfaces 21b of the carrier bosses 21 contact each other by a force of the resilient member 5, constraining upward movement of the carrier 20 and continuously maintaining a state where the pedal force is completely adjusted.

Meanwhile, in order to loosen a pedal force of the pedal arm 2, after the pedal arm housing cover 6 and the carrier housing cover 7 are separated from the pedal arm housing 1 and the carrier housing 10, the wings 23 of the carrier 20 are resiliently deformed to be shrunk toward the center of the carrier 20.

Then, as the carrier bosses 21 are separated from the housing bosses 11, the carrier 20 can be moved freely. Then, after lifting the carrier 20 whose movement is free, the operator assembles the carrier 20 in the carrier housing 10 again to adjust a pedal force of the pedal arm 1.

Then, the separated pedal arm housing cover 6 and carrier housing cover 7 are assembled again to completely adjust a pedal force adjusting operation.

As mentioned above, the pedal force adjusting apparatus according to the present invention can adjust a resilient force of the resilient member 5 through movement of the carrier 20 without exchanging the friction shoe 4 and the resilient member 5, so that a pedal force of the pedal arm 2 can be adjusted.

Accordingly, the apparatus according to the present invention can easily adjust a pedal force of the pedal arm 2 with a simple operation if necessary. In particular, the present invention faithfully satisfies safety rules for pedal force and allows a common use of an accelerator pedal.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A pedal force adjusting apparatus for an accelerator pedal, comprising:
a carrier housing integrally formed with a pedal arm housing facing an end of a pedal arm in a rotating direction of the pedal arm, the carrier housing including housing bosses integrally formed on opposing inner surfaces; and
a carrier installed within the carrier housing such that one end of a resilient member providing a pedal force to the pedal arm is supported thereby, the carrier having carrier bosses integrally protruding from opposite side surfaces thereof and coupling with respective ones of the housing bosses.

2. The pedal force adjusting apparatus of claim 1, wherein the carrier is installed in the carrier housing through coupling of the housing bosses and the carrier bosses so as to be moved in a direction of compressing the resilient member while an external force is applied.

3. The pedal force adjusting apparatus of claim 1, wherein cutaway recesses are formed on opposite sides of the carrier facing the housing bosses, a pair of wings which can be resiliently shrunk are integrally formed in the carrier with the cutaway recesses being interposed therebetween, and the carrier bosses are integrally formed on outer surfaces of the wings.

4. The pedal force adjusting apparatus of claim 1, wherein each housing boss includes an inclined surface downwardly inclined toward the pedal arm housing from an inner side surface of the carrier housing, and a perpendicular surface connected to an end of the inclined surface in a direction perpendicular to an inner side surface of the carrier housing wherein the inclined surfaces and the perpendicular surfaces are alternately formed one by one continuously along a moving direction of the carrier.

5. The pedal force adjusting apparatus of claim 3, wherein for smooth resilient movements of the wings, the remaining surfaces of each cutaway recess except one surface by which one end of the resilient member is supported are opened.

6. The pedal force adjusting apparatus of claim 4, wherein each carrier boss includes an inclined surface and a perpendicular surface surface-contacting the inclined surface and the perpendicular surface of the corresponding housing boss, and the inclined surfaces and the perpendicular surfaces are alternately formed one by one continuously along a moving direction of the carrier.

7. The pedal force adjusting apparatus of claim 1, wherein a tool insert hole connected to the outside is formed in the carrier housing facing an end of the resilient member, and the pedal force adjusting apparatus further includes a pedal force adjusting tool inserted into the tool insert hole to push the carrier.
